(19) United States
(12) Patent Application Publication
(10) Pub. No.: US 2007/0165292 A1
(43) Pub. Date: Jul. 19, 2007

(54) Apparatus and method for displaying image

(75) Inventor: Byeung-leul Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/592,266

(22) Filed: Nov. 3, 2006

(30) Foreign Application Priority Data
Jan. 17, 2006 (KR) 10-2006-0004858

(51) Int. Cl. G02B 26/08

(52) U.S. Cl. 359/212

(57) ABSTRACT

An apparatus and method are provided for displaying an image by raster scanning using a mirror. The apparatus includes a mirror control unit that controls a vertical motion of the mirror to be a triangle wave motion, and a scanning unit that repeatedly performs a forward scan and a reverse scan over the mirror in an orthogonal direction. The apparatus can reduce ringing by controlling the vertical motion of the mirror to be an isosceles triangle wave motion and increasing a sawtooth flyback time to about 50%. Also, since the reverse scan is performed during flyback after the forward scan is performed, the apparatus can compensate for a reduction in screen brightness, which is caused by the increase of the sawtooth flyback time to about 50%.

### CROSS-REFERENCE TO RELATED PATENT APPLICATION

This application claims priority from Korean Patent Application No. 10-2006-0004858, filed on Jan. 17, 2006, in the Korean Intellectual Property Office, the disclosure of which is incorporated herein in its entirety by reference.

### BACKGROUND OF THE INVENTION

1. Technical Field

Apparatuses and methods consistent with the present invention relate to displaying an image by raster scanning using a mirror, and more particularly, to an apparatus and method for displaying an image, which can reduce ringing by increasing a sawtooth flyback time and prevent a reduction in screen brightness due to the increase in the sawtooth flyback time by controlling the vertical motion of a mirror to be a triangle wave motion and repeatedly performing a forward scan in first in first out (FIFO) order and a reverse scan in last in first out (LIFO) order over a mirror in an orthogonal direction.

2. Description of the Related Art

In the related art, raster scanning is used for display devices, such as computer monitors or television receivers, to form an image by scanning horizontal scan lines in sequence from the top-left of a screen to the bottom-right. More specifically, raster scanning produces an image by converting digital image information stored in a frame buffer into analog signals using a digital-to-analogue converter (DAC) and sending the analog signals to a fluorescent screen with electron beams to scan horizontal scan lines up to down (i.e., top to bottom). The electron beams illuminate pixels where the image information exits. In general, the electron beams are moved across the screen at 60 frames/sec. Since each of the pixels in the frame buffer includes information, it is possible to operate the screen of a monitor in terms of units of dots.

FIG. 1 is a perspective view conceptually illustrating a related art apparatus for displaying an image using raster scanning. An electron beam scanning unit 100 scans electron beams, which represent predetermined digital image information, to a mirror 110.

The mirror 110 sequentially projects the electron beams scanned by the electronic scanning unit 100 from top-left to bottom-right. The mirror 110 performs a horizontal motion θ and a vertical motion φ as shown in FIG. 2. The horizontal motion θ is performed as shown in FIG. 3A, and the vertical motion φ is performed as shown in FIG. 3B, so as to form an image 120.

To display an image at 60 frames/sec, the mirror 110 of the related art image displaying apparatus using the raster scanning needs to vertically move with a 60 Hz sawtooth waveform. An external force represented by a sum of a plurality of 60 Hz harmonic waves is also required.

The related art image displaying apparatus using the raster scanning and the mirror must reduce distortion in the motion of the mirror 110 to obtain a high quality image. However, the related art image displaying apparatus cannot increase the natural frequency because increasing the natural frequency would create a difficulty for the vertical motion of the mirror 110. Accordingly, ringing of the mirror 110 occurring due to an interaction between the harmonic distortion caused during the 60 Hz linear driving and the natural vibration mode of the mirror 110 results in image distortion as shown in FIG. 4.

Three related art approaches to reduce ringing occurring in the related image displaying apparatus using the raster scanning are as follows.

A first related art approach is to increase a vertical natural frequency of a scanner. When Q factors are set the same as shown in FIGS. 5A through 5C, and vertical natural frequencies are set to 800 Hz in FIG. 5A, 1600 Hz in FIG. 5B, and 2400 Hz in FIG. 5C, it can be seen from FIGS. 5A through 5C that ringing is reduced as the vertical natural frequency of the scanner increases.

A second related art approach is to reduce a Q factor. When vertical natural frequencies are set the same as shown in FIGS. 6A through 6C, and Q factors are set to 120 in FIG. 6A, 60 in FIG. 6B, and 30 in FIG. 6C, it can be seen from FIGS. 6A through 6C that ringing is reduced as the Q factor increases.

A third related art approach is to increase a sawtooth flyback time. When sawtooth flyback times are set to 10% in FIG. 7A, 20% in FIG. 7B, and 30% in FIG. 7C, it can be seen from FIGS. 7A through 7C that ringing is reduced as the sawtooth flyback time increases.

However, the approach of increasing the vertical natural frequency of the scanner or reducing the Q factor in order to reduce ringing is difficult to implement because the scanner is highly complex in design and construction.

Also, the approach of increasing the sawtooth flyback time to reduce ringing leads to a reduction in screen brightness since an image display time decreases as the sawtooth flyback time increases.

### SUMMARY OF THE INVENTION

The present invention provides an apparatus and method for displaying an image, which can reduce ringing by increasing a sawtooth flyback time and prevent a reduction in screen brightness by controlling a vertical motion of a mirror to be a triangle wave motion and repeatedly perform a forward scan in first in first out (FIFO) order and a reverse scan in last in first out (LIFO) order over the mirror in an orthogonal direction.

According to an aspect of the present invention, there is provided an apparatus for displaying an image by raster scanning using a mirror, the apparatus comprising: a mirror control unit controlling a vertical motion of the mirror to be a triangle wave motion; and a scanning unit repeatedly performing a forward scan and a reverse scan over the mirror in an orthogonal direction.

The mirror control unit may control the vertical motion of the mirror to be an isosceles triangle wave motion.

The scanning unit may perform the forward scan in FIFO order and the reverse scan in LIFO order.

The scanning unit may perform the reverse scan using a frame buffer.

According to another aspect of the present invention, there is provided a method of displaying an image by raster scanning using a mirror, the method comprising: controlling a vertical motion of the mirror to be a triangle wave motion; and repeatedly performing a forward scan and a reverse scan over the mirror in an orthogonal direction.

The controlling of the vertical motion of the mirror may comprise controlling the vertical motion of the mirror to be an isosceles triangle wave motion.

The repeatedly performing of the forward scan and the reverse scan may comprise performing the forward scan in FIFO order and the reverse scan in LIFO order.

The repeatedly performing of the forward scan and the reverse scan may comprise performing the forward scan using a frame buffer.

According to still another aspect of the present invention, there is provided a computer-readable recording medium having embodied thereon a program for the method.

### BRIEF DESCRIPTION OF THE DRAWINGS

The above and other aspects of the present invention will become more apparent by describing in detail exemplary embodiments thereof with reference to the attached drawings in which:

FIG. 1 is a perspective view for explaining the concept of a related art apparatus for displaying an image by raster scanning;

FIG. 2 is a perspective view of a two-dimensional scanner for raster scanning in the related art image displaying apparatus of FIG. 1;

FIG. 3A is a graph illustrating a horizontal motion of the related art two-dimensional scanner of FIG. 2;

FIG. 3B is a graph illustrating a vertical motion of the related art two-dimensional scanner of FIG. 2;

FIG. 4 is a view illustrating vertical ringing occurring in the related art image displaying apparatus of FIG. 1;

FIGS. 5A through 5C are graphs illustrating a relation between vertical ringing and a vertical natural frequency of the scanner of FIG. 2 in the related art image displaying apparatus of FIG. 1;

FIGS. 6A through 6C are graphs illustrating a relation between vertical ringing and a Q factor in the related art image displaying apparatus of FIG. 1;

FIGS. 7A through 7C are graphs illustrating a relation between vertical ringing and a sawtooth flyback time in the related art image displaying apparatus of FIG. 1;

FIG. 8 is a block diagram of an apparatus for displaying an image according to an exemplary embodiment of the present invention;

FIG. 9 is a flowchart illustrating a method of displaying an image according to an exemplary embodiment of the present invention; and

FIGS. 10 and 11 are graphs for explaining the image displaying apparatus and method of FIGS. 8 and 9 according to an exemplary embodiment of the present invention.

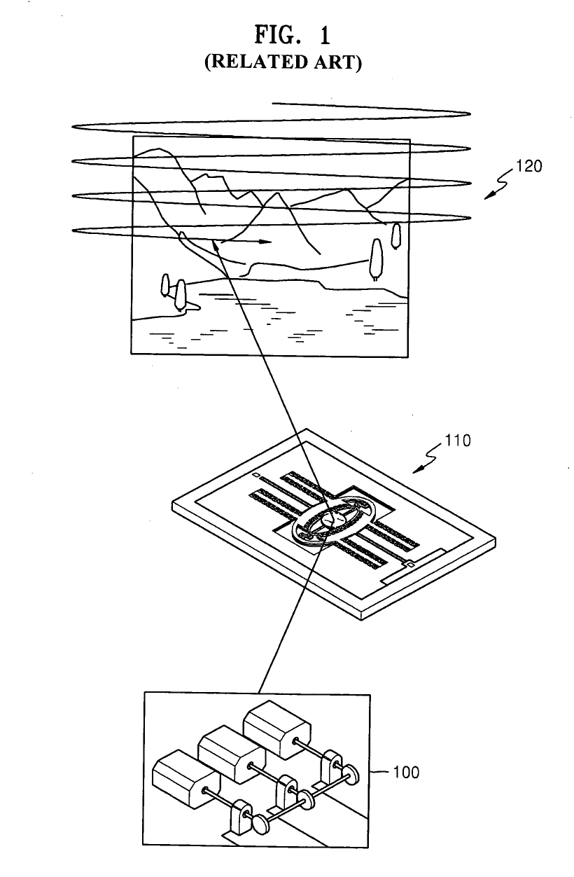

### DETAILED DESCRIPTION OF EXEMPLARY EMBODIMENTS OF THE INVENTION

The exemplary embodiments will now be described more fully with reference to the accompanying drawings.

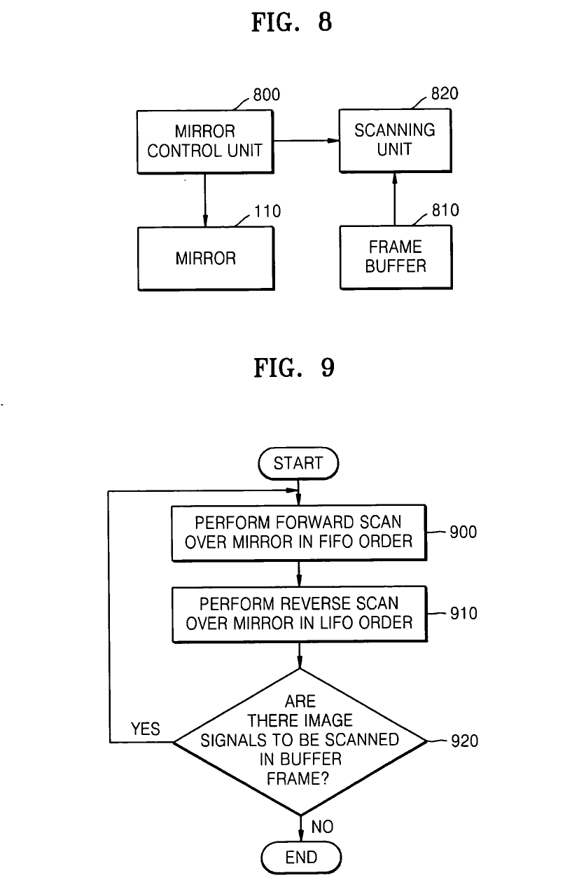

FIG. 8 is a block diagram of an apparatus for displaying an image according to an exemplary embodiment of the present invention. The image displaying apparatus includes a mirror 110, a mirror control unit 800, a frame buffer 810, and a scanning unit 820.

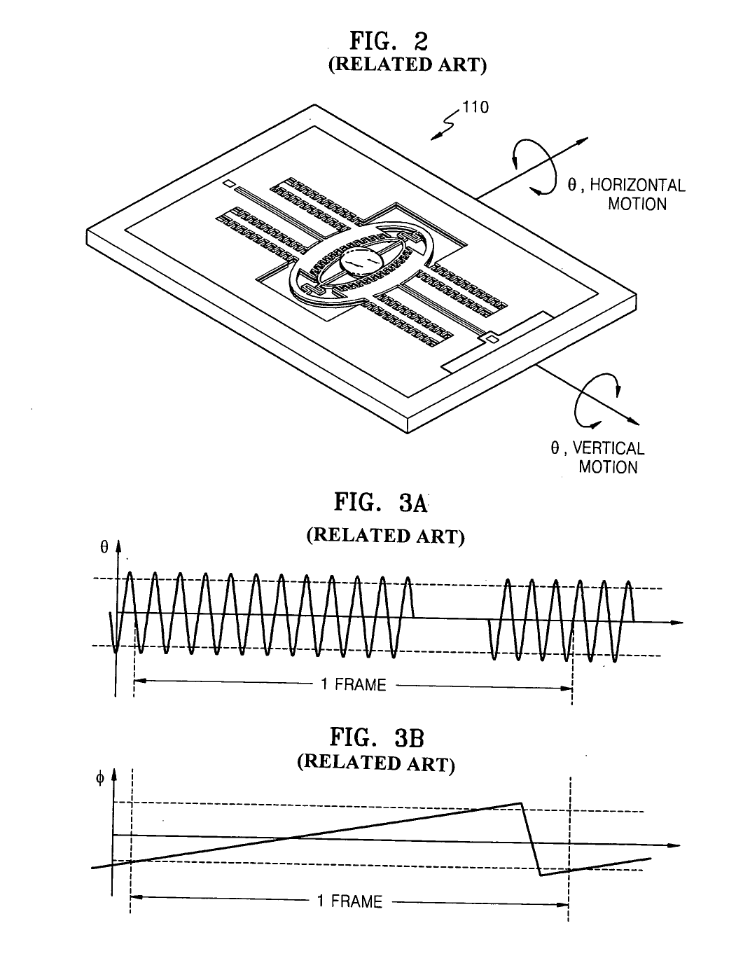

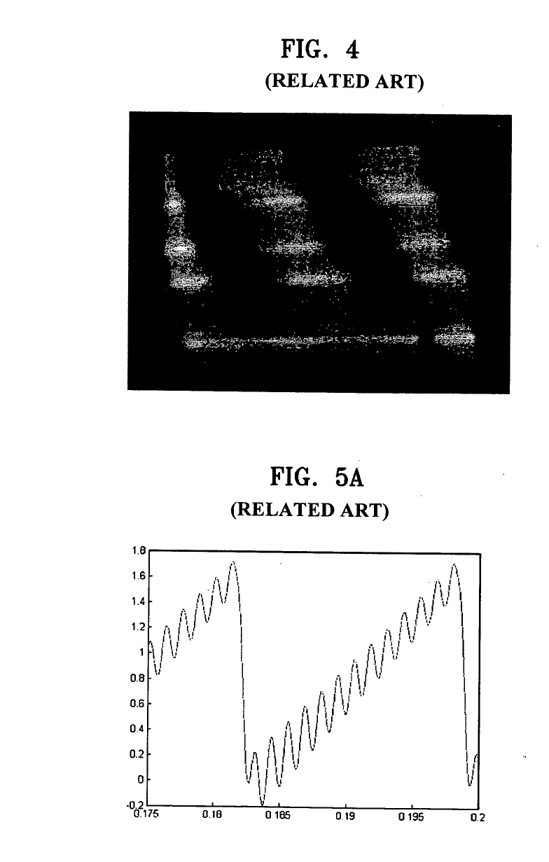

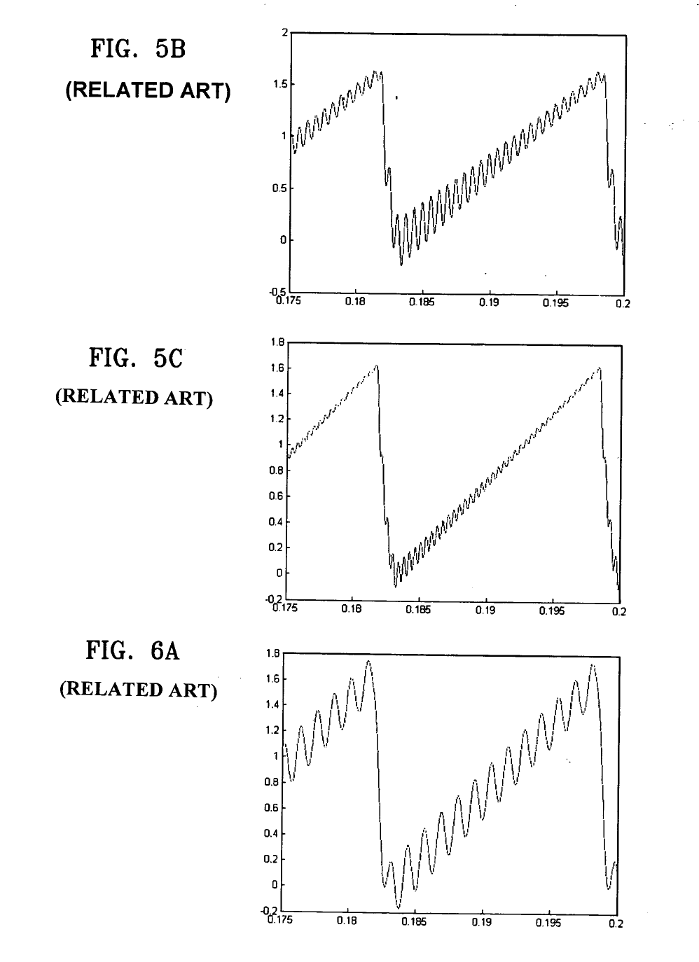

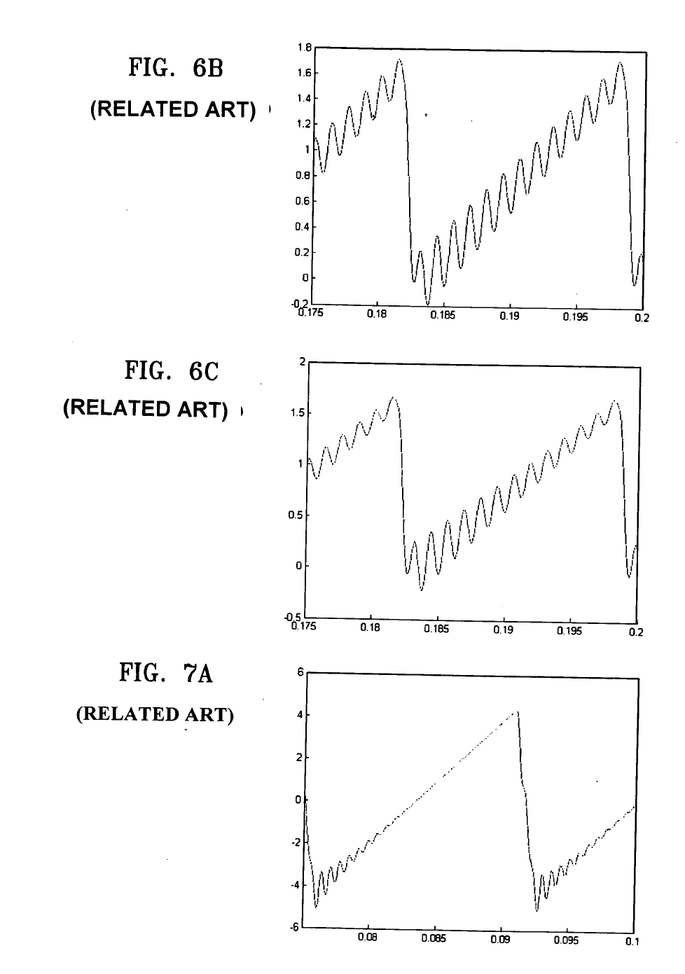

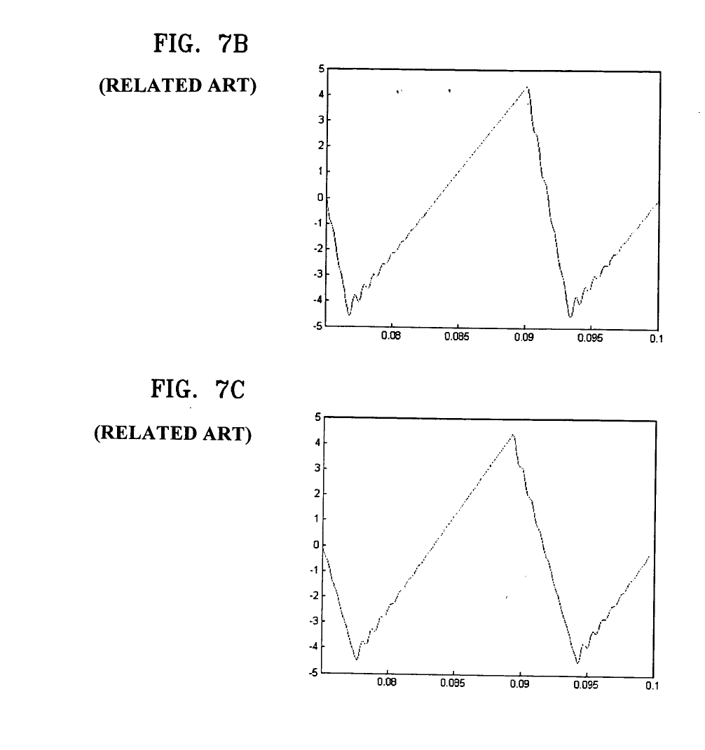

The mirror 110 forms a projection image by reflecting electron beams scanned by the scanning unit 820. The mirror 110 performs a horizontal motion θ and a vertical motion φ as shown in FIG. 2. The horizontal motion θ is performed as shown in the graph of FIG. 3A and the vertical motion φ is performed as shown in the graph of FIG. 3B.

The mirror control unit 800 controls the vertical motion φ of the mirror 110 to be a triangle wave motion as shown in FIG. 11 instead of the related art sawtooth wave motion. For example but not by way of limitation, the mirror control unit 800 may control the vertical motion φ of the mirror 110 to be an isosceles triangle wave motion by setting a sawtooth flyback time to about 50%. For example, but not by way of limitation, the mirror control unit 800 may be a mirror control circuit, and the scanning unit may be a scanning device or a scanning circuit.

The frame buffer 810 stores image signals to be scanned in units of frames. The frame buffer 810 outputs the image signals in first in first out (FIFO) order when the scanning unit 820 performs a forward scan, and outputs the image signals in last in first out (LIFO) order when the scanning unit 820 performs a reverse scan.

The scanning unit 820 repeatedly performs the forward scan and the reverse scan to move the electron beams to the mirror 110 in an orthogonal direction. The scanning unit 820 performs the forward scan in FIFO order with respect to the image signals stored in the frame buffer 810 and performs the reverse scan in LIFO order during their flyback.

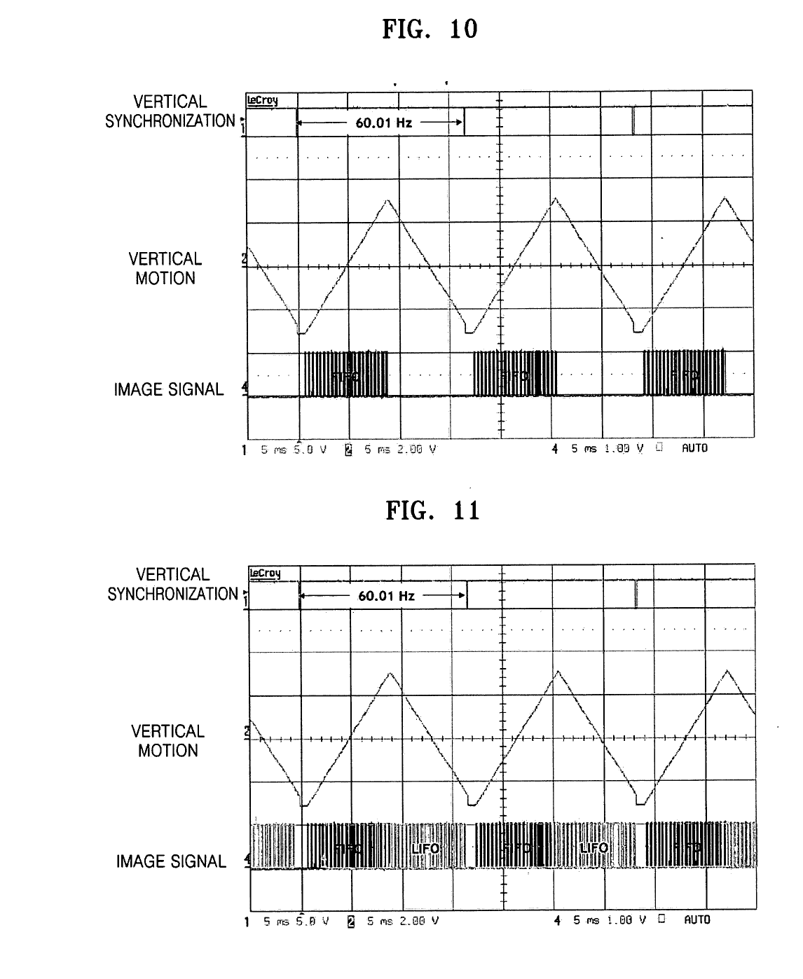

Since the mirror control unit 800 controls the vertical motion φ of the mirror 110 to be the isosceles triangle wave motion, sawtooth flyback time can be increased to about 50% as shown in FIG. 10, thereby significantly reducing ringing. In this case, while the ringing is reduced in FIG. 10, the brightness of an entire screen is limited to about 50%.

However, the reduced brightness of the screen due to the increase in the sawtooth flyback time by the mirror control unit 800 can be compensated for when the scanning unit 830 performs the reverse scan in LIFO order as shown in FIG. 11, during the flyback of the electron beams after the forward scan.

FIG. 9 is a flowchart illustrating a method of displaying an image according to an exemplary embodiment of the present invention.

In operation 900, a forward scan is performed in FIFO order over a mirror by increasing a sawtooth flyback time to about 50% for image signals stored in a frame buffer.

In operation 910, a reverse scan is performed in LIFO order for the image signals, which were forwardly scanned in operation 900, during flyback.

Each forward scan performed in operation 900 and the reverse scan performed in operation 910 is controlled to be the isosceles triangle wave motion illustrated in FIG. 11 by increasing the sawtooth flyback time to about 50%.

In operation 920, it is determined whether image signals to be scanned are stored in the frame buffer.

If it is determined in operation 920 that the image signals to be scanned are stored in the frame buffer, the process returns to operation 900. In operation 900, the image signals are forwardly scanned in FIFO order over the mirror by setting the sawtooth flyback time to about 50%.

The present invention may be embodied as computer readable codes on a computer readable recording medium. The computer readable recording medium is any data storage device that can store data which can be thereafter read by a computer system. Examples of the computer readable recording medium include read-only memories (ROMs), random-access memories (RAMs), CD-ROMs, magnetic tapes, floppy disks, and optical data storage devices, but are not limited thereto, and may include equivalents thereof as would be understood by one of ordinary skill in the art.

As described above, the image displaying apparatus and method controls the vertical motion of the mirror to be the triangle wave motion, and repeatedly performs the forward scan in FIFO order and the reverse scan in LIFO order over the mirror in the orthogonal direction.

Since the vertical motion of the mirror is controlled to be the isosceles triangle wave motion, a sawtooth flyback time can be increased to about 50% and ringing can be substantially reduced. Also, since the reverse scan is performed during flyback after the forward scan, the reduction in the screen brightness, which is caused by the increase of the sawtooth flyback time to about 50%, can be substantially compensated.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for displaying an image by raster scanning using a mirror, the apparatus comprising:
a mirror control unit which controls a vertical motion of the mirror to be a substantially triangular wave motion; and
a scanning unit which repeatedly performs a forward scan and a reverse scan over the mirror in a substantially orthogonal direction.

2. The apparatus of claim 1, wherein the mirror control unit controls the vertical motion of the mirror to be a substantially isosceles triangle wave motion.

3. The apparatus of claim 1, wherein the scanning unit performs the forward scan in a first in first out (FIFO) order and the reverse scan in a last in first out (LIFO) order.

4. The apparatus of claim 1, wherein the scanning unit performs the reverse scan using a frame buffer.

5. The method of claim 1, where the mirror control unit comprises a computer-readable medium including a set of instructions for performing the displaying of the image.

6. A method of displaying an image by raster scanning using a mirror, the method comprising:
controlling a vertical motion of the mirror to be a substantially triangle wave motion; and
repeatedly performing a forward scan and a reverse scan over the mirror in a substantially orthogonal direction.

7. The method of claim 6, wherein the controlling of the vertical motion of the mirror comprises controlling the vertical motion of the mirror to be a substantially isosceles triangle wave motion.

8. The method of claim 6, wherein the repeatedly performing of the forward scan and the reverse scan comprises performing the forward scan in a first in first out (FIFO) order and the reverse scan in a last in first out (LIFO) order.

9. The method of claim 6, wherein the repeatedly performing of the forward scan and the reverse scan comprises performing the forward scan using a frame buffer.

10. A computer-readable recording medium having embodied thereon a program for performing a method of displaying an image by raster scanning using a mirror, the method comprising:
controlling a vertical motion of the mirror to be a substantially triangle wave motion; and
repeatedly performing a forward scan and a reverse scan over the mirror in a substantially orthogonal direction.

11. The computer-readable recording medium of claim 10, wherein the controlling of the vertical motion of the mirror comprises controlling the vertical motion of the mirror to be a substantially isosceles triangle wave motion.

12. The computer-readable recording medium of claim 10, wherein the repeatedly performing of the forward scan and the reverse scan comprises performing the forward scan in a first in first out (FIFO) order and the reverse scan in a last in first out (LIFO) order.

13. The computer-readable recording medium of claim 10, wherein the repeatedly performing of the forward scan and the reverse scan comprises performing the forward scan using a frame buffer.
